(19) United States
(12) Patent Application Publication
(10) Pub. No.: US 2020/0315269 A1
(43) Pub. Date: Oct. 8, 2020

(54) Illuminated Safety Vest Assembly

(71) Applicant: Scott Roberts, Orlando, FL (US)

(72) Inventor: Scott Roberts, Orlando, FL (US)

(21) Appl. No.: 16/375,559

(22) Filed: Apr. 4, 2019

(51) Int. Cl. A41D 13/01; A41D 1/04; G08B 5/00; F21V 33/00

(52) U.S. Cl. CPC A41D 13/01; A41D 1/04; F21W 2121/06; F21V 33/0008; G08B 5/004

(57) ABSTRACT

An illuminated safety vest assembly includes a vest that is worn on a user. A plurality of reflecting strips is each coupled to the vest. Each of the reflecting strips is comprised of a light reflecting material to reflect light thereby enhancing visibility of the user when the user wears the vest in a darkened environment. A plurality of light emitters is each of the light emitter is integrated into the vest. The light emitters emit light outwardly from the vest when the light emitters are turned on thereby enhancing visibility of the user. A switch is slidably coupled to the vest and the switch is electrically coupled to each of the plurality of light emitters for turning the plurality of light emitters on and off. A plurality of conductors is each electrically coupled between the switch and a respective one of the plurality of light emitters.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety vest devices and more particularly pertains to a new safety vest device for enhancing visibility of a user in a darkened environment.

### BRIEF SUMMARY OF THE INVENTION

An embodiment of the disclosure meets the needs presented above by generally comprising a vest that is worn on a user. A plurality of reflecting strips is each coupled to the vest. Each of the reflecting strips is comprised of a light reflecting material to reflect light thereby enhancing visibility of the user when the user wears the vest in a darkened environment. A plurality of light emitters is each of the light emitter is integrated into the vest. The light emitters emit light outwardly from the vest when the light emitters are turned on thereby enhancing visibility of the user. A switch is slidably coupled to the vest and the switch is electrically coupled to each of the plurality of light emitters for turning the plurality of light emitters on and off. A plurality of conductors is each electrically coupled between the switch and a respective one of the plurality of light emitters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an illuminated safety vest assembly according to an embodiment of the disclosure.

FIG. 2 is a right side view of an embodiment of the disclosure.

FIG. 3 is a back phantom view of an embodiment of the disclosure.

FIG. 4 is a perspective in-use view of an embodiment of the disclosure.

FIG. 5 is a right side cut-away view of an embodiment of the disclosure.

FIG. 6 is a schematic view of an embodiment of the disclosure.

### DETAILED DESCRIPTION OF THE INVENTION

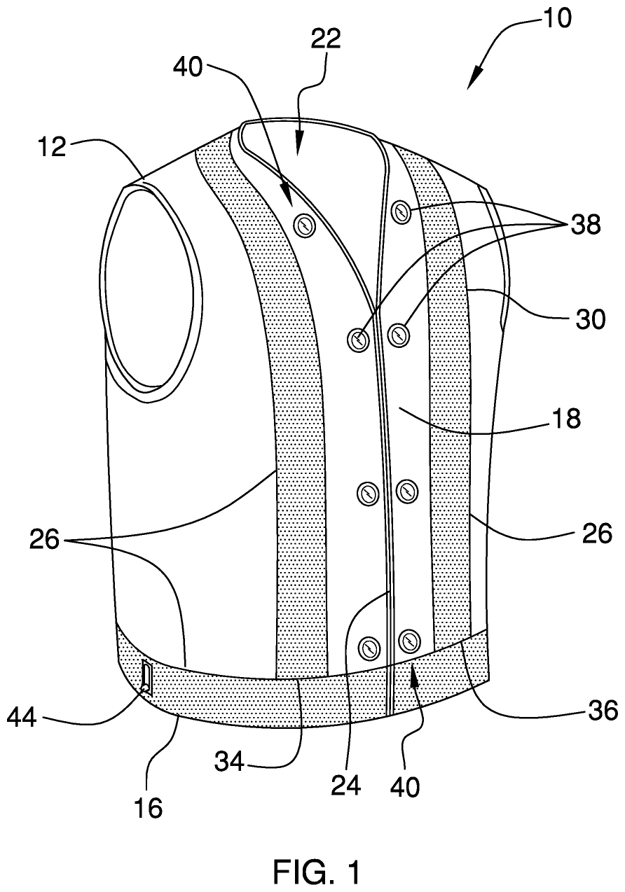

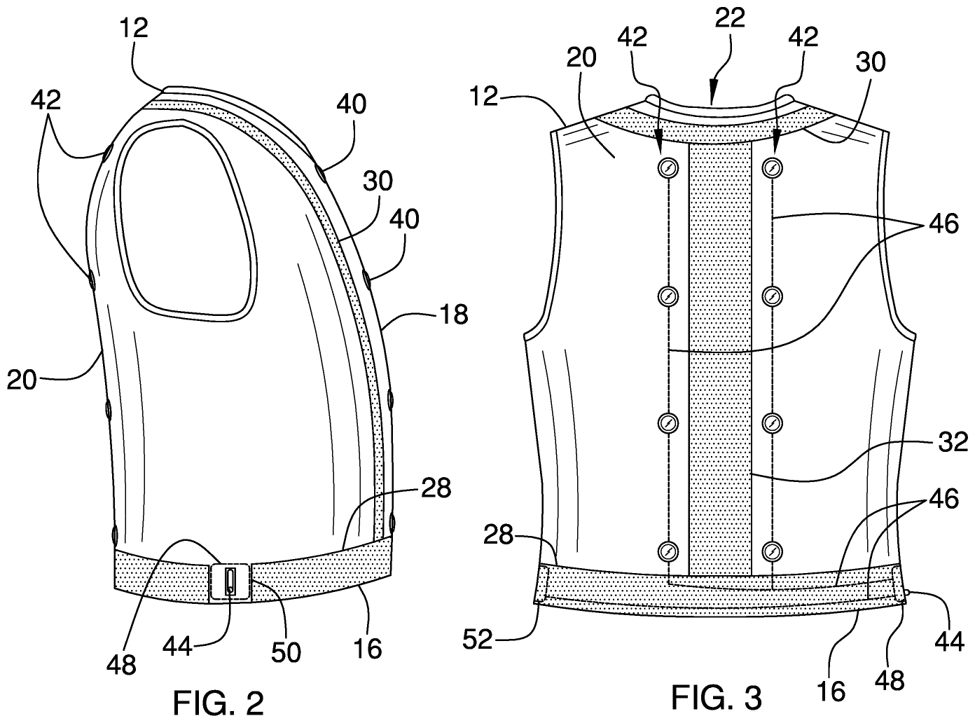

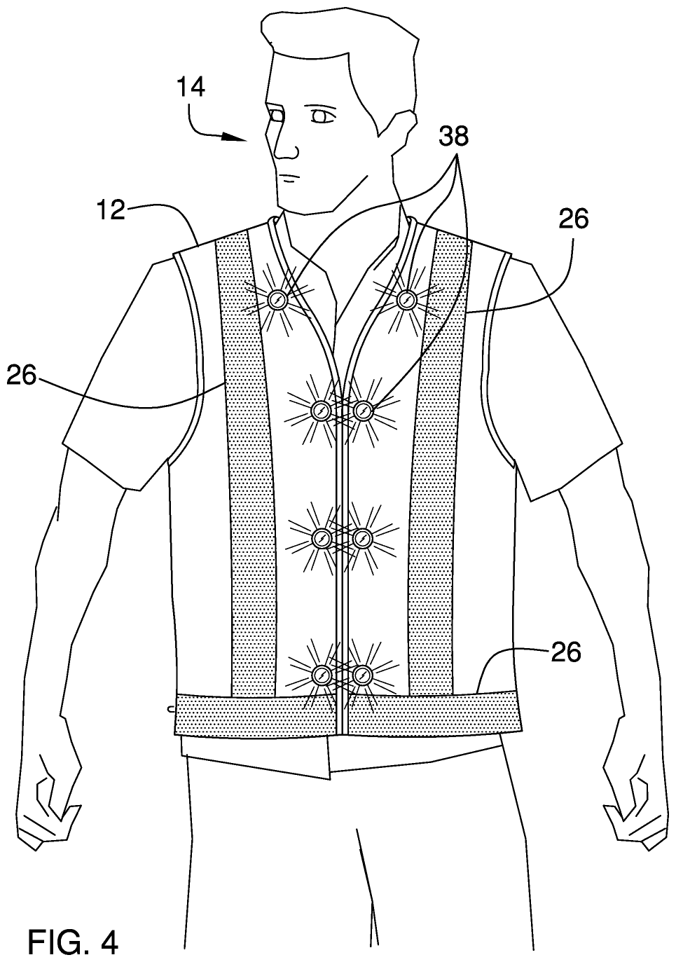

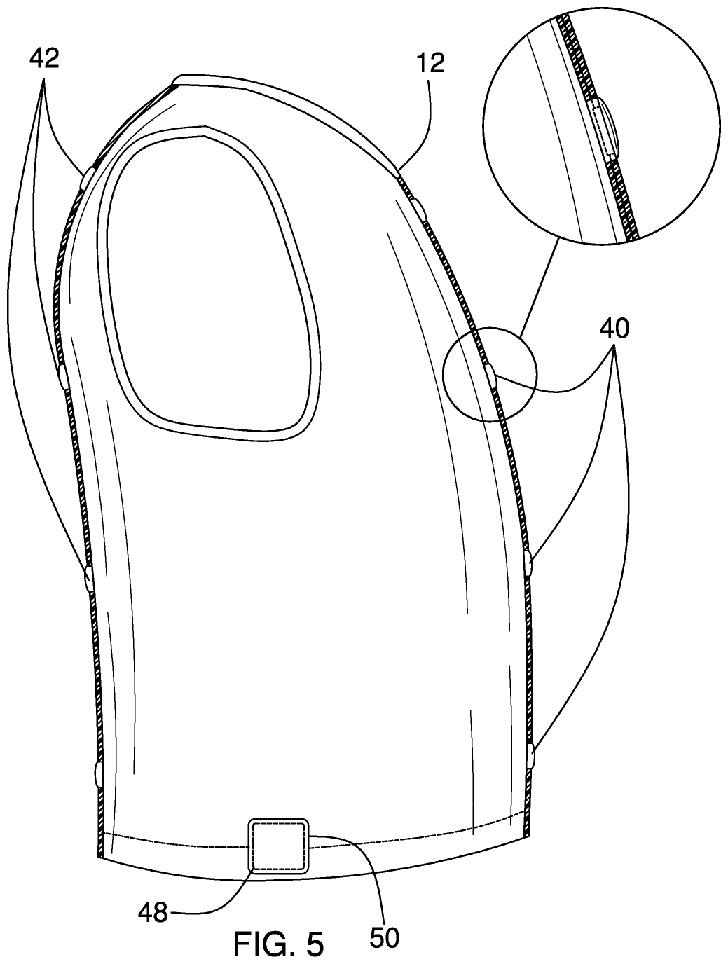

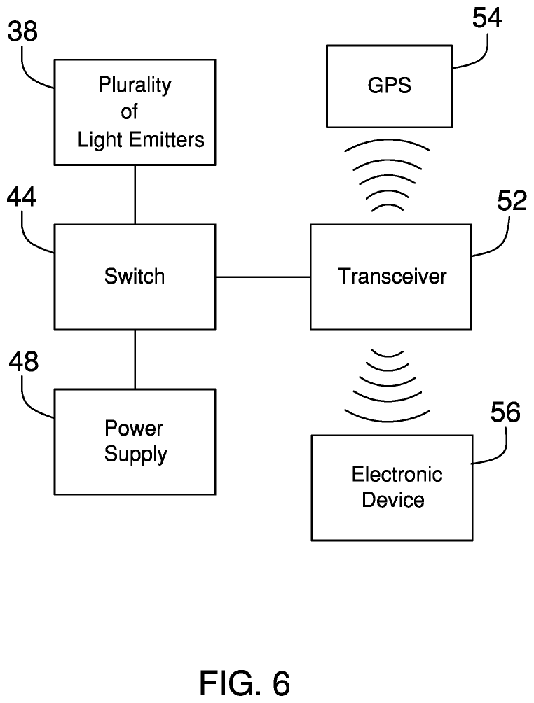

With reference now to the drawings, and in particular to FIGS. 1 through 6 thereof, a new safety vest device embodying the principles and concepts of an embodiment of the disclosure and generally designated by the reference numeral 10 will be described.

As best illustrated in FIGS. 1 through 6, the illuminated safety vest assembly 10 generally comprises a vest 12 that is worn on a user 14 when the user 14 is walking in a darkened environment. The vest 12 has a waist 16, a front 18, a back 20 and a neck opening 22. Additionally, the front 18 side has a cut 24 extending between the waist 16 and the neck opening 22. The vest 12 may be comprised of a mesh material that has a highly visible color, such as orange, yellow or other color that contrasts with a dark background.

A plurality of reflecting strips 26 is each coupled to the vest 12. Each of the reflecting strips 26 is comprised of a light reflecting material to reflect light thereby enhancing visibility of the user 14 when the user 14 wears the vest 12 in a darkened environment. Each of the reflecting strips 26 may further comprise DOT approved reflecting strips for traffic safety. The plurality of strips 26 includes a waist strip 28, a front strip 30 and a back strip 32.

The waist strip 28 is aligned with the waist 16 of the vest 12 and the waist strip 28 extends around an entire circumference of the waist 16. The front strip 30 has a first end 34 and a second end 36, and each of the first 34 and second 36 ends of the front strip 30 intersects the waist strip 28 on opposite sides of the cut 24 from each other. Additionally, the front strip 30 extends upwardly on the front 18 of the vest 12 on each side of the cut 24 and extends around the neck opening 22. The back strip 32 is centrally positioned on the back 20 of the vest 12 and the back strip 32 extends between the waist strip 28 and the front strip 30 where the front strip 30 curves around the neck opening 22.

A plurality of light emitters 38 is each integrated into the vest 12 to emit light outwardly from the vest 12 when the light emitters 38 are turned on. In this way the light emitters 38 enhance visibility of the user 14 when the user 14 wears the vest 12 in the darkened environment. Each of the light emitters 38 may comprise an LED or other type of electronic light emitter. The plurality of light emitters 38 includes a pair of sets of front light emitters 40 and a pair of sets of back light emitters 42.

Each of the sets of front light emitters 40 is positioned between on opposite sides of the cut 24 from each other. Additionally, the sets of front light emitters 40 are positioned between respective portions of the front strip 30 and the cut 24 in the vest 12. Each of the sets of front light emitters 40 is spaced apart from each other and is distributed between the waist strip 28 and the neck opening 22. Each of the sets of back light emitters 42 is positioned on opposite sides of the back strip 32 from each other. Moreover, each of the sets of the back light emitters 42 is spaced apart from each other and is distributed between the waist strip 28 and where the front strip 30 curves around the neck opening 22.

A switch 44 is slidably coupled to the vest 12 and the switch 44 is electrically coupled to each of the plurality of light emitters 38 for turning the plurality of light emitters 38 on and off. A plurality of conductors 46 is each integrated into the vest 12. Each of the conductors 46 is electrically coupled between the switch 44 and a respective one of the plurality of light emitters 38 thereby placing each of the light emitters 38 in electrical communication with the switch 44. Each of the conductors 46 may comprise insulated wires or other type of electrical conductor. A power supply 48 is coupled to the vest 12, the power supply 48 is electrically coupled to the switch 44 and the power supply 48 comprises at least one battery. Additionally, the power supply 48 may be removably positioned within a power supply housing 50 that is positioned on an inside surface of the vest 12 for concealing the power supply 48.

A transceiver 52 is coupled to the vest 12 and the transceiver 52 is electrically coupled to the power supply 48. The transceiver 52 is in wireless electrical communication with a global positioning system (gps) 54 thereby facilitating the gps 54 to establish the physical location of the vest 12. Additionally, the transceiver 52 can be placed in selective communication with an electronic device 56, such as a smart phone or the like, for tracking the location of the vest 12. In this way a parent, or other caregiver, can track the location of a child that is wearing the vest 12. The transceiver 52 may be a radio frequency transceiver or the like and the transceiver 52 may employ Bluetooth communication protocols.

In use, the vest 12 is worn when the user 14 might be walking outdoors at nighttime on or near a public roadway or the like. In this way the reflective strips 26 and the color of the vest 12 enhance visibility of the user 14 for oncoming traffic. The user 14 can manipulate the switch 44 to turn on the light emitters 38 at any time. In this way the user 14 can increase their visibility with respect to the oncoming traffic, thereby enhancing safety for the user 14. Thus, the vest 12, the reflective strips 26 and the light emitters 38 maximize visibility of the user 14 with respect to the oncoming traffic or any other individual that might be observing the user 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated safety vest assembly being configured to reflect light and emit light thereby enhancing visibility of a wearer in a darkened environment, said assembly comprising:
a vest being worn on a user, said vest having a waist, a front, a back and a neck opening, said front side having a cut extending between said waist and said neck opening;
a plurality of reflecting strips, each of said reflecting strips being coupled to said vest, each of said reflecting strips being comprised of a light reflecting material wherein said plurality of reflecting strips is configured to reflect light thereby enhancing visibility of the user when the user wears said vest in a darkened environment, said plurality of strips including a waist strip, a front strip and a back strip, said waist strip being aligned with said waist of said vest, said waist strip extending around an entire circumference of said waist;
a plurality of light emitters, each of said light emitter being integrated into said vest wherein each of said light emitters is configured to emit light outwardly from said vest when said light emitters are turned on thereby enhancing visibility of the user when the user wears said vest in the darkened environment, said plurality of light emitters including a plurality of front lights;
a switch being slidably coupled to said vest, said switch being electrically coupled to each of said plurality of light emitters for turning said plurality of light emitters on and off;
a plurality of conductors, each of said conductors being integrated into said vest, each of said conductors being electrically coupled between said switch and a respective one of said plurality of light emitters thereby placing each of said light emitters in electrical communication with said switch;
said plurality of light emitters includes a pair of sets of front light emitters and a pair of sets of back light emitters;
each of said sets of front light emitters is positioned between respective portions said front strips and said cut in said vest, each of said sets of front light emitters being spaced apart from each other and being distributed between said waist strip and said neck opening; and
each of said sets of back light emitters is positioned on opposite sides of said back strip from each other, each of said sets of said back light emitters being spaced apart from each other and being distributed between said waist strip and where said front strip curves around said neck opening.

2. (canceled)

3. The assembly according to claim 1, wherein said front strip has a first end and a second end, each of said first and second ends of said front strip intersecting said waist strip on opposite sides of said cut from each other, said front strip extending upwardly on said front side on each side of said cut and extending around said neck opening.

4. The assembly according to claim 1, wherein said front strip extends around said neck and said back strip is centrally positioned on said back side, said back strip extending between said waist strip and said front strip.

5. An illuminated safety vest assembly being configured to reflect light and emit light thereby enhancing visibility of a wearer in a darkened environment, said assembly comprising:
a vest being worn on a user, said vest having a waist, a front, a back and a neck opening, said front side having a cut extending between said waist and said neck opening;
a plurality of reflecting strips, each of said reflecting strips being coupled to said vest, each of said reflecting strips being comprised of a light reflecting material wherein said plurality of reflecting strips is configured to reflect light thereby enhancing visibility of the user when the user wears said vest in a darkened environment, said plurality of strips including a waist strip, a front strip and a back strip, said waist strip being aligned with said waist of said vest, said waist strip extending around an entire circumference of said waist, said front strip having a first end and a second end, each of said first and second ends of said front strip intersecting said waist strip on opposite sides of said cut from each other, said front strip extending upwardly on said front of said vest on each side of said cut and extending around said neck opening, said back strip being centrally positioned on said back of said vest, said back strip extending between said waist strip and said front strip where said front strip curves around said neck opening;
a plurality of light emitters, each of said light emitter being integrated into said vest wherein each of said light emitters is configured to emit light outwardly from said vest when said light emitters are turned on thereby enhancing visibility of the user when the user wears said vest in the darkened environment;
a switch being slidably coupled to said vest, said switch being electrically coupled to each of said plurality of light emitters for turning said plurality of light emitters on and off;
a plurality of conductors, each of said conductors being integrated into said vest, each of said conductors being electrically coupled between said switch and a respective one of said plurality of light emitters thereby placing each of said light emitters in electrical communication with said switch;
said plurality of light emitters includes a pair of sets of front light emitters and a pair of sets of back light emitters;
each of said sets of front light emitters is positioned between respective portions said front strips and said cut in said vest, each of said sets of front light emitters being spaced apart from each other and being distributed between said waist strip and said neck opening; and
each of said sets of back light emitters is positioned on opposite sides of said back strip from each other, each of said sets of said back light emitters being spaced apart from each other and being distributed between said waist strip and where said front strip curves around said neck opening.

6. (canceled)

7. The assembly according to claim 5, further comprising a power supply being coupled to said vest, said power supply being electrically coupled to said switch, said power supply comprising at least one battery.

8. An illuminated safety vest assembly being configure reflect light and emit light thereby enhancing visibility of a wearer in a darkened environment, said assembly comprising:
a vest being worn on a user, said vest having a waist, a front, a back and a neck opening, said front side having a cut extending between said waist and said neck opening;
a plurality of reflecting strips, each of said reflecting strips being coupled to said vest, each of said reflecting strips being comprised of a light reflecting material wherein said plurality of reflecting strips is configured to reflect light thereby enhancing visibility of the user when the user wears said vest in a darkened environment, said plurality of strips including a waist strip, a front strip and a back strip, said waist strip being aligned with said waist of said vest, said waist strip extending around an entire circumference of said waist, said front strip having a first end and a second end, each of said first and second ends of said front strip intersecting said waist strip on opposite sides of said cut from each other, said front strip extending upwardly on said front of said vest on each side of said cut and extending around said neck opening, said back strip being centrally positioned on said back of said vest, said back strip extending between said waist strip and said front strip where said front strip curves around said neck opening;
a plurality of light emitters, each of said light emitter being integrated into said vest wherein each of said light emitters is configured to emit light outwardly from said vest when said light emitters are turned on thereby enhancing visibility of the user when the user wears said vest in the darkened environment, said plurality of light emitters including a pair sets of front light emitters and a pair of sets of back light emitters, each of said sets of front light emitters being positioned between respective portions of said front strip and said cut in said vest, each of said sets of front light emitters being spaced apart from each other and being distributed between said waist strip and said neck opening, each of said sets of back light emitters being positioned on opposite sides of said back strip from each other, each of said sets of said back light emitters being spaced apart from each other and being distributed between said waist strip and where said front strip curves around said neck opening;
a switch being slidably coupled to said vest, said switch being electrically coupled to each of said plurality of light emitters for turning said plurality of light emitters on and off;
a plurality of conductors, each of said conductors being integrated into said vest, each of said conductors being electrically coupled between said switch and a respective one of said plurality of light emitters thereby placing each of said light emitters in electrical communication with said switch; and
a power supply being coupled to said vest, said power supply being electrically coupled to said switch, said power supply comprising at least one battery.
